(19) United States
(12) Patent Application Publication
(10) Pub. No.: US 2005/0005128 A1
(43) Pub. Date: Jan. 6, 2005

(54) System for controlling access to stored data

(75) Inventors: Howard Shelton Lambert, Southampton (GB); Gillian Laura Woodcock, Fareham (GB); Steven Wright, Upham (GB)

Correspondence Address: IBM Corporation;IP Law Department, 11400 Burnet Road, Austin, TX, 78758, US

(73) Assignee: International Business Machines Corporation, Armonk, NY (US)

(21) Appl. No.: 10/698,174

(22) Filed: Oct. 30, 2003

(30) Foreign Application Priority Data
Jun. 26, 2003 (JP) 0314905.1

(51) Int. Cl. H04K 1/00

(52) U.S. Cl. 713/182

(57) ABSTRACT

A data processing system for controlling access of at least one user to stored data is provided. The system comprises means, responsive to a request from the user to access a set of the stored data, for authenticating the user. The system also comprises means, responsive to successful authentication, for decrypting an encrypted data structure associated with the user. The data structure comprises data associated with the set (e.g. location of the set). The system also comprises means, responsive to successful decryption, for accessing the set.

### FIELD OF THE INVENTION

This invention relates generally to the control of access to stored data.

### BACKGROUND OF THE INVENTION

An example of such a service is the dispensing of cash by an automatic teller machine (ATM). Access to facilities provided by the ATM are typically controlled by requiring a user to present a personalised plastic card carrying data on a magnetic stripe to a card reader associated with the ATM. The user is required to key in a personal identification number (PIN) which is used by the system to access data in the card which together with data held in the system relating to the user enables the system to determine whether the requested transaction should be authorised.

The principle has been considerably extended to many types of transactions including the purchase of goods in retail outlets, access to processes on computer networks and the provision of stockbroking services. As the sophistication of the services has increased so has the need for increased flexibility and security in the control of access. For example, it is important that providers of services through retail tills/terminals or ATM's are assured that such services may only be accessed by authorised end-users with a valid access card, at a valid till and, where appropriate, under the control of an authorised sales assistant or other operator. Applications providing services may be held on the system in an encrypted form requiring a decryption key to access them, and the decryption key is then only provided to identified authorised users when they present a valid access card. It is also desirable to provide an audit trail for each transaction to facilitate the detection of fraud and the settlement of any dispute that may arise from the transaction.

An improved form of plastic card, called the Smart Card, has been developed which by incorporating within it active data processing and storage facilities provides enhanced security and flexibility. Data and application programs can be made inaccessible until an authorised person (as identified by personal information input by that person) presents their SmartCard. The present invention is suitable for use with SmartCards but is not limited thereto.

A problem arises when seeking to control access to application program modules where a number of different users are required to be allowed to access different sets of application modules. For example, in a retail environment, it may be desirable for all till operators to run certain applets associated with sales whereas only the store manager can access other applets associated with stock control or payroll. In another example, multiple users accessing data, applications or services on a shared device (e.g. a personal computer) require access to their applicable data, applications or services without compromising the privacy of the other users.

Preferably, a secure method of accessing user specific data or applications is required. The conventional approach to the problem of secure access in a shared environment is for a computer LOG ON procedure to include identification of the user from user input data (and optionally additional data held on a token such as a SmartCard). A table lookup process then scans a static list to determine the access authority of the user, and the user is given access to certain applications according to their determined authority level.

Such conventional systems relying on lookup tables of user authorities are vulnerable to breaches of security even if the applications themselves are held in a protected (e.g. encrypted) form if the list can be tampered with. An unauthorised person may seek to add themselves to the list or to change their authority level within the list.

U.S. Pat. No. 6,282,649 issued on Aug. 28, 2001 discloses one solution to this problem. The security of stored data and applications is improved by an access control system and method in which user keys for accessing the stored data/services are representative of the user's level of authority, such that there is no need to maintain a separate lookup table of user authority levels. This removes a potential security exposure from the system. The user keys are hierarchical, including data for generating a plurality of different access keys for each of a plurality of different access levels. The access keys may be decryption keys for encrypted data or application programs.

### SUMMARY OF THE INVENTION

According to a first aspect, the present invention provides a data processing system for controlling access of at least one user to stored data comprising: means, responsive to a request from the user to access a set of the stored data, for authenticating the user; means, responsive to successful authentication, for decrypting an encrypted data structure associated with the user, wherein the data structure comprises data associated with the set; and means, responsive to successful decryption, for accessing the set.

Preferably, the data associated with the set comprises data associated with the location of the set and data associated with decryption of the set, if the set has been encrypted. In one embodiment, the set comprises all of the stored data. In another embodiment, the set comprises a portion of the stored data.

Preferably, the user request is initiated by presentation of a token by the user. In one embodiment, the token is a SmartCard. In a preferred embodiment, the token comprises means associated with the identity of the user. In one embodiment, the means associated with the identity of the user is a key. In another embodiment, the means associated with the identity of the user is a digital certificate. Preferably, the means associated with the identity of the user is derived from one or more biometric characteristics associated with the user, for example, a facial characteristic or a fingerprint.

In a preferred embodiment, the token comprises the means for decrypting the encrypted data structure. In one embodiment, the means for decrypting is the same as the means associated with the identity of the user (e.g. a key).

Preferably, the stored data is capable of access by more than one user (i.e. a shared system). In this case, the system further comprises means for accessing a data structure comprising data associated with each user of the more than one user. Preferably, the data structure is unencrypted and comprises data associated with the users that have access to the system (e.g. user name) and the location of each of the users' associated data structure.

Preferably, the data includes applications or services or both. In one embodiment, the data is stored on a remote system. In a preferred embodiment, the data structures are stored on the system. In an alternative embodiment, the encrypted data structure associated with the user is stored on the token. Advantageously, the data structures are easy to maintain e.g. to handle a change in the data that the user has access to; to handle addition/removal of users that have access to the system, etc.

According to a second aspect, the present invention provides a method for controlling access of at least one user to stored data via a data processing system comprising the steps of: in response to a request from the user to access a set of the stored data, authenticating the user; in response to successful authentication, decrypting an encrypted data structure associated with the user, wherein the data structure comprises data associated with the set; and in response to successful decryption, accessing the set.

According to a third aspect, the present invention provides a computer program comprising program code means adapted to perform the steps of the method described above, when said program is run on a computer.

### BRIEF DESCRIPTION OF THE DRAWINGS

The present invention will now be described, by way of example only, with reference to preferred embodiments thereof, as illustrated in the following drawings:

FIG. 1 shows an environment in which the present invention may be implemented;

FIG. 2 shows a more detailed overview of the environment of FIG.1, wherein a user accesses a device;

FIG. 3 shows a more detailed overview of the environment of FIG.1, wherein a user accesses a shared device;

FIG. 4 is a flow chart showing the operational steps involved when a user accesses a device as shown in FIG. 2; and

FIG. 5 is a flow chart showing the operational steps involved when a user accesses a shared device as shown in FIG. 3.

### DETAILED DESCRIPTION OF THE INVENTION

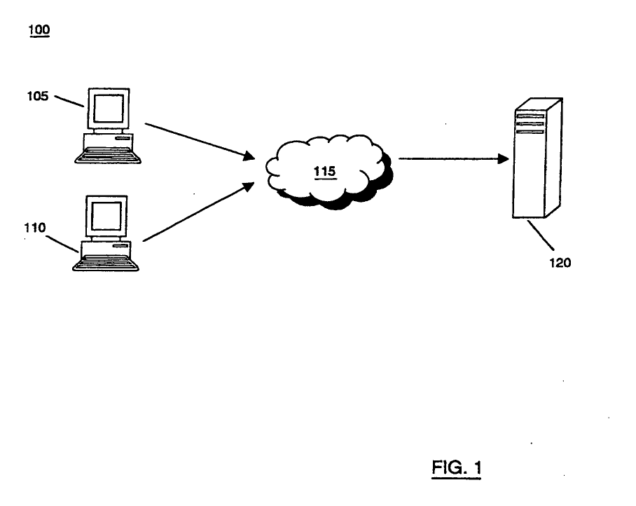

FIG. 1 shows a pictorial representation of an environment (100) in which a preferred embodiment of the present invention may be implemented. There is shown multiple users (105), each having access to a shared device (110) (e.g. a personal computer, a personal digital assistant (PDA) etc.).

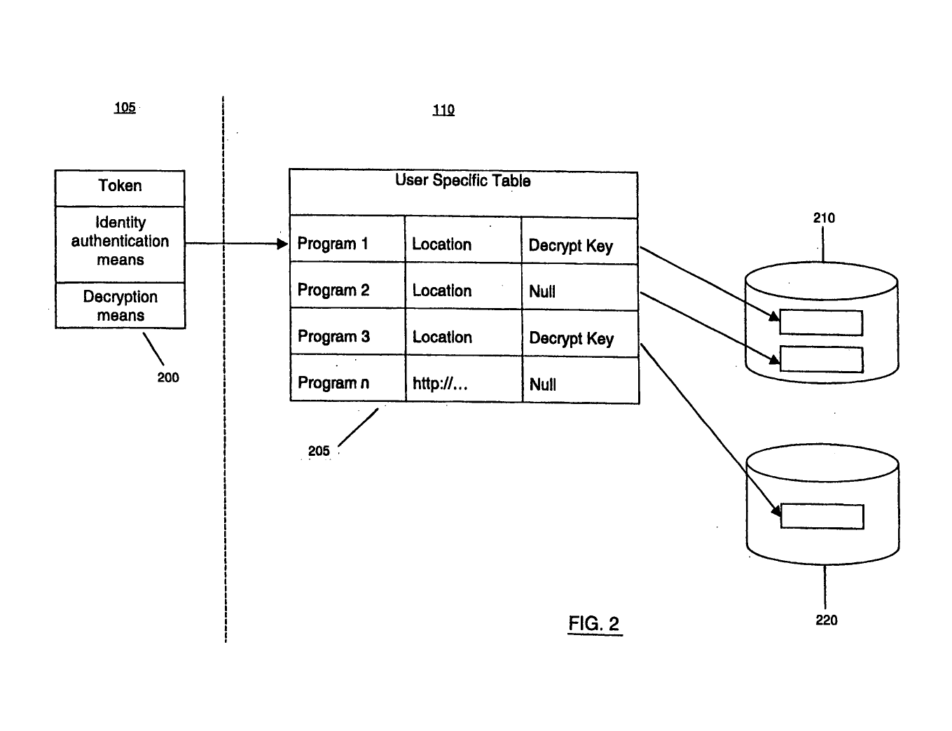

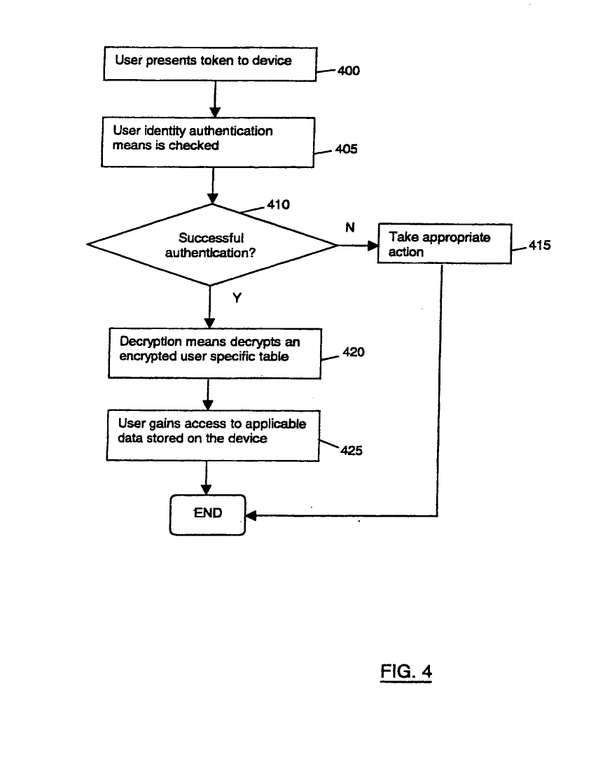

Referring to FIG. 2 and FIG. 4, there is shown an overview of an environment wherein a user has access to a device (110), the device comprising stored data. Preferably, a user presents (step 400) a token (200) (e.g. a SmartCard) to the device (110). Preferably, a user identity authentication means is stored on the SmartCard (200), for example a key. In one embodiment, a user enters some personal data (e.g. a Personal Identification Number (PIN)) after the SmartCard (200) is presented to the shared device (110) and a hashing algorithm is applied to the PIN in order to dynamically generate a key on the SmartCard (200) itself. However in a more advanced system the key may be generated from biometric data read by a reader adapted to recognise particular facial or other characteristics of the user such as fingerprint or hand geometry. In an alternative embodiment, an authentication key is pre-generated and stored on the SmartCard (200). In yet another embodiment, the user identity authentication means is a digital certificate comprising a key and a user id.

Upon presentation (step 400) of the SmartCard (200) to the device (110), in the example described herein, a key is generated in order to identify the user. The device (110) comprises means for authenticating (step 405) the key and in this way, the identity of the user is authenticated.

If authentication succeeds (positive result to step 410), preferably, decryption means on the SmartCard (200) (e.g. the same key used to authenticate the user, or another key) is used to decrypt (step 420) an encrypted “user specific table” (205) stored on the shared device (110).

Alternatively, the decryption means can be stored on the device (110). Successful decryption allows the user (105) to access the table, whereby the table comprises data associated with a set of the stored data that the user has access to. In one embodiment, the set comprises all of the stored data. In another embodiment, the set comprises a sub-set of the stored data.

Preferably, the table identifies the name(s) of the stored data (e.g. Program 1, Program 2, Program 3, Program n); the location of the stored data in storage (210, 220) on the device (110) (i.e. “Location”, a URL (Universal Resource Locator) etc.); and a decrypt key needed to decrypt the stored data if the data has been stored in an encrypted form. If the data has not been stored in an encrypted form, a decrypt key is not required. Once the user has accessed his/her user specific table, he/she gains access (step 425) to the set of stored data as required e.g. via hyperlinks, pointers etc.

The table (205) is encrypted so that only the authenticated user can view the table that is applicable to him/her (via an appropriate decrypt process). Therefore, the function of the user specific table (205) is to identify the set of stored data that is available to the authenticated user.

If authentication does not succeed (negative result to step 410), appropriate action is taken (step 415), for example, a “warning” message or a “retry” message is displayed to the user. It should be understood that in the case of authentication failure, preferably, the user will not be able to access any functionality on the device at all. For example, the user will not be able to view the data that is installed. Alternatively, the user's access to functionality on the device (110) is restricted.

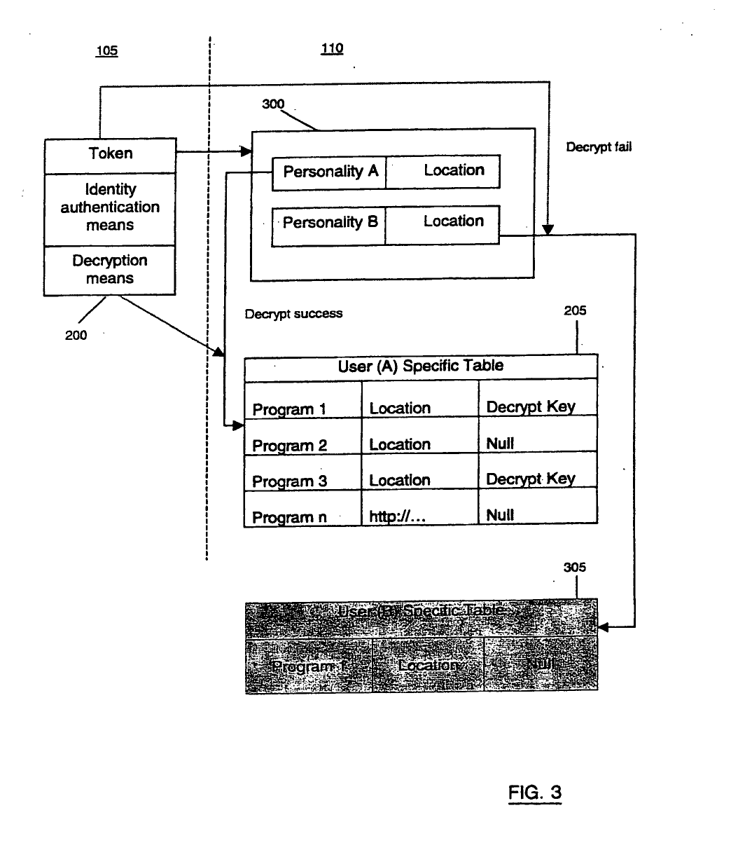

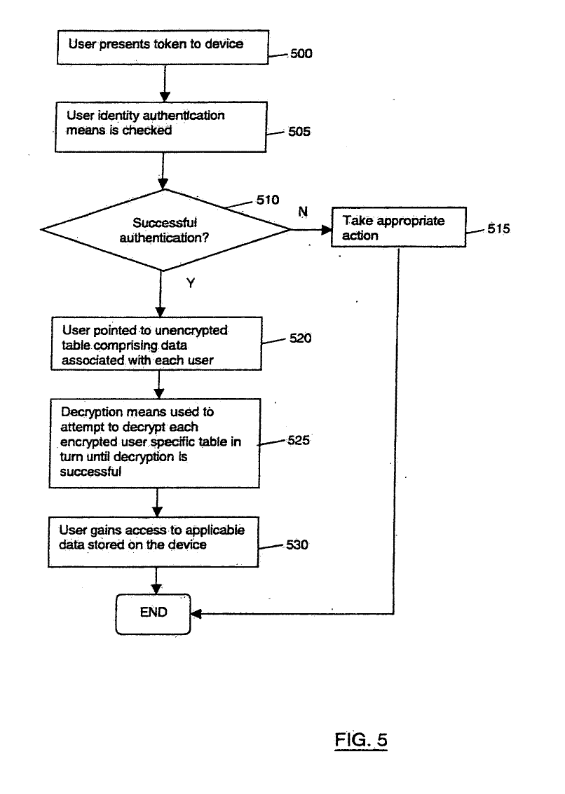

Referring to FIG. 3 and FIG. 5, there is shown an overview of an environment wherein a user accesses a device (110) shared amongst multiple users. The device comprises stored data. Preferably, each user has an associated token, in this example, a SmartCard (200), whereby a user identity authentication means is stored on their SmartCard (200). As described above, the user identity authentication means is a key, a digital certificate etc. In this example, the user's user identity authentication means is a key. Preferably, for each user, a corresponding user specific table exists (i.e. tables 205 and 305 in FIG. 3) on the device (110), each of the tables being individually encrypted.

Firstly, the user (A) presents (step 500) their SmartCard (200) to the device (110) in order to request access to a set of the stored data. Next, the user identity authentication means (in this example, a pre-generated key) is authenticated by authentication means on the device (110). This allows authentication (step 505) of the user. If authentication succeeds (positive result to step 510), the user is pointed (step 520) to an unencrypted table (300), which stores details of all the users that have access to the device (110) (“Personality”) and the location of each of the users' user specific table (“Location”).

Next, decryption means on the SmartCard (200) (e.g. a key) is used to attempt to decrypt (step 525) each of the user specific tables (i.e. tables 205 and 305) in turn until a successful decryption occurs. It should be understood that the location of the user specific tables has been provided by table 300. As shown in FIG. 3, the authenticated user has successfully decrypted table 205 and therefore gains (step 530) access to his/her “user specific table” (205), which comprises data associated with the set of the stored data that the user has access to. By encrypting user specific tables so that only the corresponding user can decrypt the table, each user has access only to the table that is applicable to him/her. This enables “personalities” to be assigned to the shared device (100) so that when an authenticated user logs on to the device, only the set of the stored data, that is applicable to that user, is made available.

If authentication does not succeed (negative result to step 510), appropriate action is taken (step 515), for example, a “warning” message or a “retry” message is displayed to the user. It should be understood that in the case of authentication failure, preferably, the user will not be able to access any functionality on the device at all. Alternatively, the user's access to functionality on the device (110) is restricted.

While the present invention has been described above in relation to access to a shared device, it will be appreciated that it is applicable in any situation where access is sought to processes or other potentially sensitive material in the course of a token initiated transaction. For example it may readily be applied to environments such as the Internet in which access is sought to software and may only be granted if the requestor is appropriately authorised.

The present invention can be advantageously applied to thin clients, which have little or no application logic (e.g. mobile phones, PDAs etc.) since thin clients such as mobile phones already have processing capability. Advantageously, little modification of existing hardware is required in order to enable the thin clients to make use of the access control mechanism of the present invention.

The present invention is preferably embodied as a computer program product for use with a computer system. Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

1. A data processing system for controlling access of at least one user to stored data comprising:
means, responsive to a request from the user to access a set of the stored data, for authenticating the user;
means, responsive to successful authentication, for decrypting an encrypted data structure associated with the user, wherein the data structure comprises data associated with the set; and
means, responsive to successful decryption, for accessing the set.

2. A data processing system as claimed in claim 1, wherein the data associated with the set comprises data associated with the location of the set.

3. A data processing system as claimed in claim 1, wherein the set is encrypted and the data associated with the set comprises data associated with decryption of the set.

4. A data processing system as claimed in claim 1, wherein the set comprises all of the stored data.

5. A data processing system as claimed in claim 1, wherein the set comprises a portion of the stored data.

6. A data processing system as claimed in claim 1, wherein the user request is initiated by presentation of a token by the user.

7. A data processing system as claimed in claim 6, wherein the token comprises means associated with the identity of the user.

8. A data processing system as claimed in claim 7, wherein the means associated with the identity of the user is derived from one or more biometric characteristics associated with the user.

9. A data processing system as claimed in claim 6, wherein the token comprises the means for decrypting.

10. A data processing system as claimed in claim 1, wherein the stored data is capable of access by more than one user, the system further comprises means for accessing a data structure comprising data associated with each user of the more than one users.

11. A method for controlling access of at least one user to stored data via a data processing system comprising the steps of:
in response to a request from the user to access a set of the stored data, authenticating the user;
in response to successful authentication, decrypting an encrypted data structure associated with the user, wherein the data structure comprises data associated with the set; and
in response to successful decryption, accessing the set.

12. A computer program comprising program code means adapted to perform the steps of claim 11, when said program is run on a computer.
